(19) United States
(12) Patent Application Publication
(10) Pub. No.: US 2025/0136222 A1
(43) Pub. Date: May 1, 2025

(54) Electric vehicle comprising a cavity for a battery, and assembly method

(71) Applicant: DECATHLON, VILLENEUVE D’ASCQ (FR)

(72) Inventor: David PETITDEMANGE, VILLENEUVE D’ASCQ (FR)

(21) Appl. No.: 18/687,825

(22) PCT Filed: Jul. 22, 2022
(86) PCT No.: PCT/EP2022/070586

§ 371 Date: Feb. 29, 2024

(30) Foreign Application Priority Data
Sep. 1, 2021 (FR) 2109144

(51) Int. Cl. B62J 43/28; B62J 43/13; H01M 50/249; H01M 50/262; H01M 50/271

(52) U.S. Cl. CPC B62J 43/28; B62J 43/13; H01M 50/249; H01M 50/262; H01M 50/271; H01M 2220/20

(57) ABSTRACT

An electric vehicle includes a hollow housing with an opening for inserting a battery. The battery includes a box extending along a longitudinal direction, between two longitudinal ends and along a longitudinal side of the box. The battery further includes a cover, for example of dimensions smaller than the dimensions of the insertion opening, and a battery support mounted inside the hollow housing, to allow the installation or withdrawal of the battery on the support, through the insertion opening. The support includes two parts configured to cooperate with the two longitudinal ends of the battery box. Along at least one spatial direction, the two support parts are mounted in a fixed and non-adjustable manner relative to the hollow housing, and the cover is mounted in an adjustable manner on the battery box.

### TECHNICAL FIELD

The present disclosure relates to the field of electric vehicles, and in particular the field of electric bicycles. More specifically, the present disclosure relates to electric vehicles that include a housing for accommodating a battery.

### BACKGROUND

It is known to design vehicles driven by an electric motor. Thus, for many years there have been bicycles with electric motors and batteries, in order to provide users with motor assistance.

The electric drive means are thus becoming more and more widespread, and there is now a desire to integrate such electric drive means into the bicycle frame, for aesthetic purposes but also a desire to protect against bad weather even against theft.

There are thus means for integrating the battery into one of the tubes of the bicycle frame, in particular in the downtube. Such frames are described in document US 2019/337588. The purpose of the integration means is to allow the positioning of the battery inside the bicycle frame, when using the bicycle, while also allowing rapid and easy withdrawal of the battery out of the frame to allow its recharge.

Particularly, the bicycle frame conventionally includes a portion forming an internal housing and having an opening making it possible to insert a battery into the internal housing or extract it therefrom. The battery also includes a cover intended to close, when the battery is mounted in the housing, the opening of the frame, for aesthetic and protective purposes.

However, achieving correct alignment between the cover and the opening of the frame can be a challenge. Indeed, since the cover is mounted on the battery box, for example by slides, it is the position of the battery box that will define the position of the cover.

However, the batteries are, as standard, held in place relative to the frame by longitudinal support means secured to the frame and also ensuring electrical contact and/or locking functions.

The integration of the batteries into the bicycle frames thus requires either support means that can be adjusted in position, or components, both for the support means and for the battery box, having dimensions whose tolerances are very low, in order to allow correct positioning of the cover relative to the frame.

However, the decrease in the tolerances generally leads to an increase in the price of the component.

Moreover, the adjustment of the positioning of the support means is generally carried out in iterations, generally requiring successive insertions and withdrawals of the battery into and out of the housing, which increases the duration of manufacture of the bicycle.

### SUMMARY

The present disclosure aims to solve the various technical problems stated previously. Particularly, the present disclosure aims to provide an electric vehicle with an aesthetically integrated battery that is easy to extract from the vehicle. More specifically, the present disclosure aims to provide an electric vehicle in which the integration of the battery can be performed both simply and aesthetically, while remaining inexpensive.

Thus, according to one aspect, an electric vehicle includes:
a hollow housing, for example a hollow frame, with an opening for inserting a battery,
a battery including a box extending along a longitudinal direction, between two longitudinal ends and, along a longitudinal side of the box, a cover, for example of dimensions smaller than the dimensions of the insertion opening, and
a battery support mounted inside the hollow housing, so as to allow the installation or withdrawal of the battery on the support, through the insertion opening, the support including two parts configured to cooperate with the two longitudinal ends of the battery box.

According to at least one spatial direction, in particular along the longitudinal direction of the box and/or along a direction transverse to the longitudinal direction of the box when the box is positioned in the hollow housing, the two support parts are mounted in a fixed and non-adjustable manner relative to the hollow housing, and the cover is mounted in an adjustable manner on the battery box.

Thus, according to the present disclosure, the positioning of the cover is no longer determined by the positioning of the battery box but can on the contrary be performed relative to the battery box. The battery can therefore be positioned with standard tolerances in the housing of the vehicle, without requiring a particularly fine placement: the cover is only positioned in a second step, when the battery is positioned in the housing. It is then no longer necessary to provide an adjustment of the battery support means, or of the compounds with low dimensional tolerances, to be able to obtain the desired positioning and the desired aesthetic effect on the final vehicle with integrated battery.

Particularly, the present disclosure provides for an adjustment of the cover on the battery box, along at least one direction in which the battery support means are not provided to be adjusted relative to the battery accommodation housing. The means and the time to be implemented are therefore facilitated to obtain the desired positioning of the cover relative to the housing along at least said direction. The adjustment of the cover on the box can thus be done along the longitudinal direction of the box and/or along a direction transverse to the longitudinal direction of the box when the box is mounted in the hollow housing.

Preferably, the two support parts are mounted in a fixed and non-adjustable manner relative to the hollow housing along two spatial directions, and the cover is mounted in an adjustable manner on the battery box along at least one of said two spatial directions, preferably along said two spatial directions.

In this case, the cover can be positioned relative to the battery along at least one spatial direction, preferably two spatial directions. Such an embodiment is particularly advantageous in particular, but not only, when the cover extends substantially in a plane: in this case, the at least one spatial direction preferably the two spatial directions, according to which the cover is mounted in an adjustable manner on the battery box, is(are) advantageously the, at least one among the, preferably the, two directions defining the plane in which the cover extends substantially, namely the longitudinal direction of the box and a direction transverse to the longitudinal direction of the box. It is then possible to easily and accurately position the cover relative to the opening of the housing, and more particularly each of the edges of the cover relative to the opening of the housing.

Preferably, the two support parts are mounted on a substantially planar surface of the hollow housing. Along the direction perpendicular to said surface of the hollow housing, the two support parts are mounted in a fixed and non-adjustable manner relative to the hollow housing, and the cover is mounted in an adjustable manner on the battery box.

In such an embodiment, the position of the support parts can be adjusted in the plane, or at least along one direction of said plane, of the surface of the hollow housing during the mounting that is to say during the fixing of said support parts on said surface of the hollow housing. However, the position of the support parts cannot be adjusted along the direction perpendicular to the plane of said surface of the hollow housing during the mounting of the support parts on said surface. The cover is then mounted on the box in an adjustable manner along said direction perpendicular to the plane of said surface of the hollow housing on which said support parts are mounted.

In the case of a planar cover, the surface of the hollow housing on which the first and second support parts are mounted is then perpendicular to the plane of the cover.

Preferably, the two parts of the support and/or the battery box are configured to exert a longitudinal tightening stress between the battery box and the support, preferably at the level of, or in the vicinity of, or near, the fixing of at least one of the two parts of the support on the inside of the hollow housing.

In order to limit the displacement of the battery in the housing, which could cause unpleasant noise for the user, or even create damage to the mechanical and/or electrical connections between the battery box and the support parts, it is provided to exert a longitudinal tightening stress between the box and the support. Longitudinal stress is advantageously exerted in the vicinity of the fixings of the support parts on the hollow housing, so that the longitudinal stress is directly transmitted to the fixing means and therefore to the hollow housing. This improves the holding of the battery in the housing. This also limits the torsional stresses that can be exerted at the level of the support parts, which makes it possible to provide supports made of less rigid material, and therefore less expensive and less heavy.

Preferably, the battery includes means for fixing the cover to the box, said fixing means including a tightening system, for example a screw-nut assembly, mounted with clearance in an opening in the box, for example an oblong opening whose dimensions are smaller than those of the nut but greater than those of the screw.

To allow the adjustment of the positioning of the cover relative to the battery box, the cover can be mounted on said box via a tightening system. Particularly, the means for fixing the cover on the box are configured to allow a clearance of the cover relative to the box, along at least one direction: in other words, the fixing means make it possible, before tightening, to move the cover relative to the box along at least one direction. Once the cover is correctly positioned along said at least one direction, it is then sufficient to use the system for tightening the fixing means to immobilize the desired position of the cover relative to the battery box.

Thus, the fixing means can comprise a screw-nut assembly, or bolt, mounted in an opening of the box and/or of the cover which has a surface area greater than the cross section of the screw of the bolt but with at least one dimension smaller than that of the bolt nut and of the screw head. In this case, the box and/or the cover could move relative to the screw when the bolt will not be tightened. On the other hand, once the bolt is tightened, the cover and the box will then be immobilized in position relative to each other.

The use of such means for fixing the cover to the battery box advantageously makes it possible to position and tighten the cover on the box without having to introduce the battery into the housing and extract it therefrom several times. It is sufficient to place the battery in the housing once, then to position the cover as desired relative to the opening of the housing, before tightening the fixing of the cover. Indeed, unlike the battery supports whose fixings on the housing are located inside said housing, the means for fixing the cover on the battery are accessible from outside the housing, which facilitates their use.

Preferably, one of the parts of the support comprises a longitudinal tightening means, for example a pad mounted, along the longitudinal direction of the battery box, on an elastic means.

To maintain a longitudinal pressure on the battery when it is mounted in the housing, whatever the tolerance observed on the dimensions of the battery box, at least part of the support comprises a longitudinal tightening means making it possible to compensate for said tolerance on the dimensions of the battery box. The longitudinal tightening means is advantageously a pad that is to say a means for bearing with a main surface constituting a contact surface, preferably substantially planar surface, mounted on an elastic means, such as a leaf spring or one or several coil springs. The elastic means makes it possible to move the pad along the longitudinal direction, until it comes into contact, or bears, against the battery box. Once the pad is in contact with the box, the elastic means makes it possible to obtain a longitudinal pressure between the pad and the box, making it possible to limit the unwanted longitudinal movements of the box in the housing.

Preferably, the cover is substantially planar and the position of the cover can be adjusted relative to the box along at least one spatial direction of the plane of the cover, preferably along the two spatial directions of the plane of the cover, in particular the longitudinal direction of the box and/or a direction transverse to the longitudinal direction of the box.

According to one embodiment, the cover can have a substantially planar general shape and be intended to be positioned in the continuity of a substantially planar surface of the vehicle frame. In this case, the position of the cover can be advantageously adjusted along the two spatial directions defining the plane in which the cover extends, to be able to adjust the positioning of the different edges of the cover relative to the housing insertion opening. In other words, it is then possible and easy to position the cover relative to the housing so that the gap between it and the housing is substantially the same all around the cover.

Preferably, the cover extends substantially in a plane including the longitudinal direction of the box and a direction transverse to the longitudinal direction of the box. According to said longitudinal direction and/or said transverse direction when the box is positioned in the hollow housing, the two support parts are mounted in a fixed and non-adjustable manner relative to the hollow housing, and the cover is mounted in an adjustable manner on the battery box.

Preferably, at least one of the two parts of the battery support is made of plastic, preferably of injected plastic.

As indicated previously, the electric vehicle according to the present disclosure allows fine and accurate positioning of the cover relative to the box, and therefore to the housing, even in the event of variation in the tolerances on the dimensions of the box in particular. The same applies in the event of slight deformations of one or several parts of the support under the effect of the weight of the battery or under the effect of the longitudinal pressure exerted between the box and the parts of the support. Thus, such deformation could also be compensated by the adequate positioning of the cover on the battery box, to maintain an aesthetic appearance and a desired protective function. It is therefore not necessary to provide for the support parts having high rigidities, to overcome possible deformations, but on the contrary it is then possible to manufacture one or several support parts made of plastic, in particular of injected plastic, while allowing always having a correct positioning of the cover. Such plastic support parts present in particular the advantage of having a lower weight than similar metal parts for example, for a much lower cost as well.

According to another aspect, described is also a method for mounting a battery support and a battery inside a hollow housing of an electric vehicle with an insertion opening. The battery includes a box extending along a longitudinal direction, between two longitudinal ends and, along a longitudinal side of the box, a cover, for example of dimensions smaller than the dimensions of the insertion opening. The battery support includes two parts, preferably made of plastic, configured to cooperate with the two longitudinal ends of the battery box.

According to the method, the two parts of the support are fixed inside the hollow housing of an electric vehicle in a non-adjustable manner along at least one spatial direction, in particular along the longitudinal direction of the box or along a direction transverse to the longitudinal direction of the box when the box is positioned in the hollow housing; the battery is installed on the support, inside the hollow housing of the electric vehicle; and the position of the cover is adjusted along said at least one spatial direction on the battery box relative to the insertion opening of the hollow housing, preferably in a centered manner.

As can be seen, the adjustment of the position of the cover is carried out when the battery is positioned in the housing. It is therefore not necessary to remove the battery from its housing to carry out the adjustment: this is carried out directly on the battery in the position of use, which allows finer and faster adjustment.

Preferably, the cover extends substantially in a plane including the longitudinal direction of the box and a direction transverse to the longitudinal direction of the box and, along said longitudinal direction or said transverse direction, the position of the cover is adjusted on the battery box relative to the insertion opening of the hollow housing, preferably in a centered manner.

Preferably, when the battery is installed on the support, a longitudinal stress is exerted between the two parts of the support and the battery, preferably at the level of, or in the vicinity of, or near, the fixing of at least one of the two parts of the support on the inside of the hollow housing.

The longitudinal stress makes it possible to hold the battery box in position relative to the support, and therefore to hold the cover in position relative to the insertion opening, in use. There is therefore no risk of change in the cover position relative to the insertion opening, due to a change in the position of the battery box relative to the support.

Preferably, the two parts of the support are fixed on the hollow housing using a template.

Thanks to the electric vehicle according to the present disclosure, it is possible to obtain correct positioning of the cover relative to the housing, despite the stresses that may be exerted between the battery box and the support, or despite the variations in the dimensions of the box. In other words, the device and the method according to the present disclosure make it possible to absorb the variations in the dimensions of the battery box, while allowing the cover to remain correctly placed. Thus, the battery support can be mounted in the housing in a unique way, by always providing for the same distance between the two parts of the support, which can be done using a template. The mounting of the two parts of the support is therefore all the easier and faster since anticipation or adjustment according to a possible tolerance in the dimension of the battery box is not necessary.

The template thus makes it possible to set the distance between the two parts of the support. The template can also be configured to cooperate with the insertion opening. In this case, the template makes it possible to position the two parts of the support not only therebetween, but also relative to the insertion opening. Only the positioning of the support parts along, for example, a direction perpendicular to the plane of the cover, can then remain necessary before definitive immobilization of the support parts in the housing.

Preferably, the position of the cover is adjusted on the battery box using a set of preferably V-shaped peripheral spacers simultaneously positioned between the different sides of the cover and the insertion opening when adjusting the position of the cover.

In order to quickly and correctly position the cover relative to the housing, it is possible to use a centering tool configured to leave the same space between the different sides of the cover and the edges of the insertion opening of the housing, For example, the centering tool can include several spacers, preferably at least one per side of the cover, connected together by a body that can form a handle. The spacers are intended to be positioned all simultaneously between the cover and the edge of the insertion opening. Moreover, the spacers also advantageously have a V shape, to insert the same gap between the sides of the cover and the edges of the insertion opening, by simple translation of the centering tool along a direction perpendicular to the cover.

### BRIEF DESCRIPTION OF THE DRAWINGS

FIG. 1 represents a perspective view of a portion of an electric bicycle frame according to the present disclosure, with a battery housing;

FIG. 2 represents a sectional view of the electric bicycle frame portion illustrated in FIG. 1;

FIG. 3 represents a second support part for a battery, intended to hold a battery in the housing of the electric bicycle frame;

FIG. 4 represents a first support part for a battery, intended to hold a battery in the housing of the electric bicycle frame;

FIG. 5 represents a side view of a battery for an electric bicycle frame; and

FIG. 6 represents a tool for positioning a cover, during the fixing on a battery box.

### DESCRIPTION OF THE EMBODIMENTS

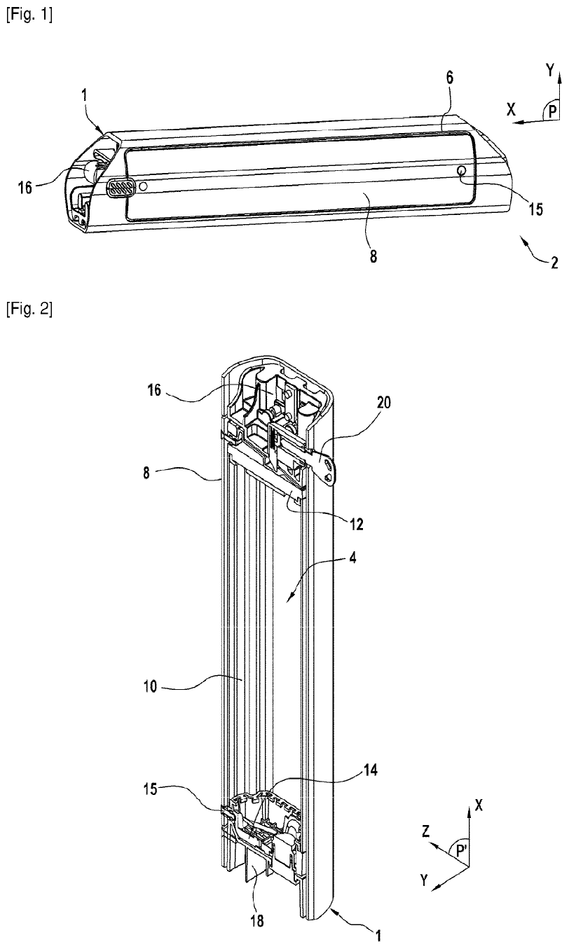

FIG. 1 schematically illustrates a hollow housing 1 of an electric vehicle 2. The hollow housing 1 can be formed, for example, by a frame portion of the electric vehicle 2. Said frame portion of the electric vehicle 2 can be in the form of a tube whose wall delimits a free interior volume. The electric vehicle 2 can be a bicycle, or a cargo ship, a mobile bicycle, etc.

In the case of an electric bicycle, the hollow housing 1 can be formed for example in the downtube or in the upper tube of the bicycle frame. However, other positions can also be envisaged, in particular elsewhere than in the frame.

The hollow housing 1 thus includes a free interior volume intended to accommodate a removable battery 4. To allow access to said interior volume, the hollow housing 1 includes an insertion opening 6 allowing the insertion of the battery 4 into the hollow housing 1 and its withdrawal out of it. The hollow housing 1 can extend along a longitudinal direction X, particularly when it is formed by a frame tube. In this case, the battery 4 can also advantageously have a longitudinal shape to make the best use of the space available in the hollow housing.

In the example illustrated in FIGS. 1 and 2, the insertion opening 6 is obtained by a cutout made in the frame of the electric vehicle 2, for example in the wall of the tube forming the hollow housing 1.

The insertion opening 6 can be located on any one of the side faces of the hollow housing 1. For example, in the case of a hollow housing 1 provided in the downtube of an electric bicycle, the insertion opening 6 could be located on the upper face of the downtube, on the lower face or, preferably, on a side face of the downtube. Such positioning of the insertion opening 6 makes it possible in particular to remove the battery 4 from the hollow housing 1 without being hindered by the upper tube, as may be the case with an insertion opening disposed on the upper face of the downtube, and without the risk of dropping it, as may be the case with an insertion opening disposed on the lower face of the downtube.

Such an embodiment makes it possible to use the interior volume of the tube to be able to store the battery 4 therein, so as to reduce the external bulk of the battery 4. Such an embodiment also makes it possible to protect the battery 4 when using the electric vehicle 2, since it is fully integrated inside the hollow housing 1 and therefore protected against bad weather or acts of vandalism for example.

In order to hide the insertion opening 6 when using the electric vehicle 2, it is conventional to provide, on the battery 4, a cover 8 intended to re-close the insertion opening 6. The cover 8 is thus preferably provided in a similar or identical manner to the wall of the hollow housing, to limit the visual impact of the insertion opening 6 and obtain an improved aesthetic appearance.

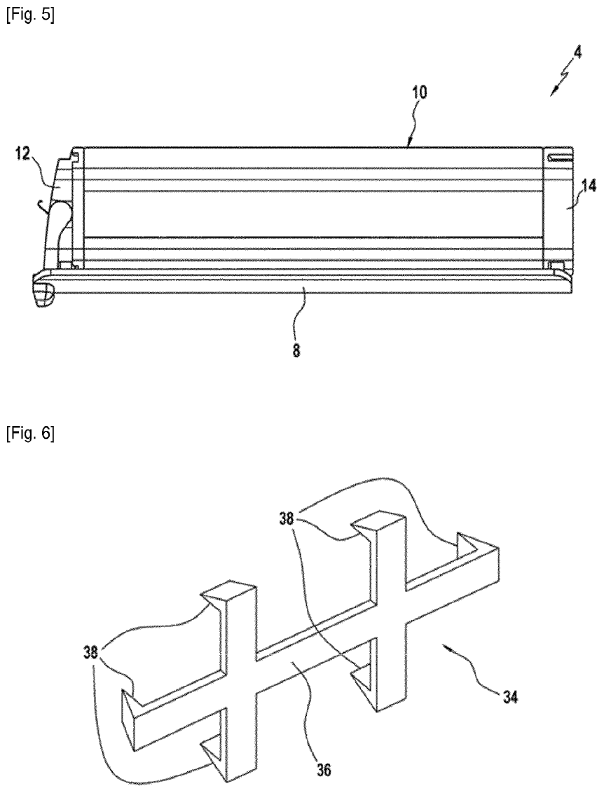

As illustrated in FIG. 5, the battery 4 also includes, in addition to the cover 8, a box 10 extending along the same longitudinal direction as the battery 4 and in which the electrochemical cells are mounted, and on which the cover 8 is fixed. To allow the integration of the battery 4 into the electric vehicle 2, and in particular the mechanical connection and the electrical connection, the box 10 includes means for connection with the hollow housing 1. In the example illustrated in FIG. 2 where the battery 4 has a longitudinal shape, the connection means are two longitudinal ends intended to cooperate with the housing 1. The box 10 therefore comprises a first longitudinal end 12 intended to allow mechanical connection of the box 10 in the hollow housing 1, and a second longitudinal end 14 intended to allow mechanical and electrical connection of the box 10 in the hollow housing 1.

Finally, the battery 4 includes means 15 for fixing the cover 8 on the box 10. The fixing means 15 is designed to allow adjustment of the position of the cover 8 relative to the box 10, and therefore relative to the insertion opening 6 of the hollow housing 1.

Indeed, in order to allow good positioning of the cover 8 relative to the insertion opening 6, in particular for aesthetic but also for sealing purposes, it is known to provide battery supports whose positioning in the hollow housing can be adjusted. However, such an adjustment requires, after having positioned the battery in said housing to identify the modifications to be made, a withdrawal of the battery and a “blind” repositioning of the supports, before putting the battery back in the housing in order to verify that the positioning obtained is indeed the desired one. Such an adjustment method therefore requires time and nevertheless remains ineffective.

According to the present disclosure, the means 15 for fixing the cover 8 on the box 10 are configured to allow adjustment of the cover 8 on the box 10, and advantageously when the battery 4 is positioned in the hollow housing 1. It is then possible to directly and correctly position the cover 8 in its final position, with the battery 4 in the hollow housing 1.

For this purpose, the fixing means 15 is configured to allow adjustment of the position of the cover 8 on the box 10, along at least one spatial direction, preferably along at least two spatial directions. In the case illustrated in FIG. 1, the cover 8 extends substantially in a plane P (see FIG. 1) and along the same longitudinal direction X (see FIGS. 1 and 2) as that of the box 10, and the fixing means 15 is configured to allow adjustment in position of the cover 8 relative to the box 10 along at least one spatial direction, preferably the two spatial directions of the plane P in which the cover 8 substantially extends, namely the longitudinal direction X of the cover 8 and/or a direction Y of the plane of the cover 8 transverse to the longitudinal direction X of the cover 8.

More concretely, the fixing means 15 is configured to allow the cover 8 to be adjusted in position in the plane P of FIG. 1, namely along the horizontal direction X and/or along the vertical direction Y.

According to one exemplary embodiment, the fixing means 15 can comprise two bolts formed, each, by a screw and a nut, and two enlarged holes, that is to say with a clearance, formed either at the level of the cover 8, or preferably at the level of the box 10. The two enlarged, for example oblong, holes are dimensioned to allow a displacement, generally of several millimeters, of the screws in the holes. It is this displacement that will make it possible to modify the position of the cover 8 relative to the box 10, and therefore to adjust the final position of the cover 8. Once the cover 8 is in the desired position, it is then sufficient to tighten the bolts to fix the cover 8 on the box 10 permanently. For example, the nut of each bolt can be positioned in a housing of the box that is wide enough to be able to move with the corresponding screw when adjusting the cover 8, but also narrow enough to prevent rotation of the nut during the rotation of the screw during the tightening.

The fixing means 15 therefore makes it possible to define the position of the cover 8 relative to the insertion opening 6, when the battery 4 is in the hollow housing 1, which facilitates and improves the correct positioning of the cover 8.

In the illustrated embodiment, the cover 8 is not adjusted in position along one of the spatial directions: it is the direction substantially perpendicular to the plane of FIG. 1. In other words, the fixing means 15 does not allow adjusting the distance between the cover 8 and the box 10: such a distance remains constant.

The positioning of the cover 8 in the plane of the hollow housing 1 can be done in particular via the supports on which the battery 4 is mounted in the hollow housing 1.

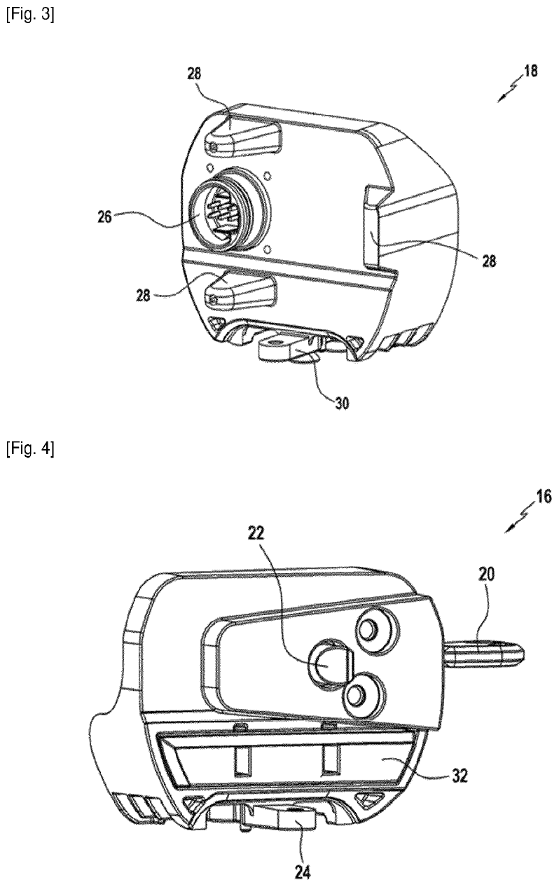

The hollow housing 1 thus includes mechanical and electrical means for connection with the box 10, in the form of two support parts: a first support part 16 and a second support part 18. The two support parts 16, 18 can be distinct from each other, as illustrated in FIGS. 3 and 4, or form part of one and the same one-piece support. The support parts 16, 18 are in particular configured to cooperate with the longitudinal ends 12, 14 of the battery box 10, in order to allow easy and effortless insertion and withdrawal of the battery 4, in particular to allow its recharging when it is partially or totally discharged.

When the first and second support parts 16, 18 are mounted on a substantially planar surface of the hollow housing 1 which belongs to the plane P′ (see FIG. 2), the cover 8 can be configured to be adjusted in position at least along the direction Y perpendicular to said plane P′ of said surface of the hollow housing 1. In the case of a planar cover 8, the plane P′ of the surface of the hollow housing 1 on which the first and second support parts 16, 18 are mounted is then perpendicular to the plane P of the cover 8.

The first support part 16 (see FIG. 4) can thus comprise a locking means 20, for example a lock, to secure the battery 4 in the hollow housing 1. The locking means 20 cooperates in particular with a finger 22 extending from the first support part 16 in order to cooperate with a recess or a corresponding abutment of the first longitudinal end 12 of the box 10. The first support part 16 can also comprise a trapezoidal-shaped guide configured to cooperate with a guide of complementary shape provided at the first longitudinal end 12 of the box, and making it possible to facilitate and guide the insertion of the battery 4 into the hollow housing 1.

The first support part 16 also includes fixing means 24 on the hollow housing 1. Such fixing means 24 are in particular intended to be adjustable only along a single spatial direction: the one perpendicular to the plane of the cover 8.

For this purpose, and in the example illustrated in FIGS. 1 to 4, the two support parts 16, 18 are fixed on a surface of the hollow housing 1 which is perpendicular to the plane of the cover 8, for example a lower surface in FIG. 1. Thus, to allow adjustment of the cover 8 along a direction substantially perpendicular to the plane in which it extends, it is sufficient to provide for fixing means 24 configured to translate in the plane of the surface on which they are fixed, and perpendicularly to the longitudinal direction of the hollow housing 1. The first support part 16 can for example be mounted on the fixing means 24 by a slide connection: the slide connection can be configured to allow a displacement of the first support part 16 along the direction perpendicular to the plane of the cover 8, and allow blocking in position, for example by tightening, when the cover 8 is correctly positioned.

Such positioning and tightening of the first support part 16 can also be carried out with the battery 4 in the hollow housing 1, from outside the hollow housing 1, by providing a screw for mounting and tightening the first support part 16 whose head is positioned on the outside of the hollow housing 1.

The second support part 18 (see FIG. 3) can thus comprise an electrical connector 26, as well as guide lugs 28 for the insertion and removal of the battery 4 in the hollow housing 1. The guide lugs 28 can in particular cooperate with corresponding recesses in the box 10.

The second support part 18 also includes means 30 for fixing on the hollow housing 1. As for the means 24 for fixing the first support part 16, such fixing means 30 are in particular provided to be adjustable only along a single spatial direction: the one perpendicular to the plane of the cover 8.

For this purpose, the fixing means 30 are configured to translate in the plane of the surface on which they are fixed, and perpendicularly to the longitudinal direction of the hollow housing 1. The second support part 18 can for example be mounted on the fixing means 30 by a slide connection: the slide connection can be configured to allow displacement of the second support part 18 along the direction perpendicular to the plane of the cover 8, and allow blocking in position, for example by tightening, when the cover 8 is correctly positioned.

Such positioning and tightening of the second support part 18 can also be carried out with the battery 4 in the hollow housing 1, from outside the hollow housing 1, by providing a screw for mounting and tightening the second part support 18 whose head is positioned on the outside of the hollow housing 1.

In order to allow a tight holding of the battery in the hollow housing 1, the support parts 16, 18 are also configured to apply a longitudinal force on the box 10 of the battery 4. Thus, the first support part 16 can comprise a longitudinal tightening means 32, for example in the form of a pad. The pad is mounted on a face of the first support part 16 which is substantially perpendicular to the longitudinal direction. The pad can have elastic properties and/or be mounted on elastic means (not represented) such as: a leaf spring or coil springs. The pad makes it possible to exert a force on the first end 12 of the box 10, perpendicular to said first end 12.

The pad makes it possible in particular to keep the battery tight and immobile relative to the hollow housing 1, in particular in use during which the electric vehicle 2 may be subject to vibrations and/or sudden jolts.

Advantageously, the pad is positioned on the side of the means 24 for fixing the first support part 16, so as to reduce the torsional forces that may appear over the distance separating the pad from the fixing means 24. The longitudinal stress between the box 10 and the supports 16, 18 is then directly taken up by the fixing means 24, 30, and therefore by the hollow housing 1 itself.

Alternatively, the longitudinal tightening means can be positioned on the battery box 10, at one of the longitudinal ends 12, 14.

Thus, such geometry makes it possible to limit the torsional stresses that may be exerted on the support parts 16, 18. It is then possible to make said support parts 16, 18 from lighter materials less expensive to manufacture. For example, the support parts 16, 18 can be made of plastic, preferably of injected plastic. Inexpensive and lighter pieces are then obtained, while having mechanical properties adapted to the constraints exerted in use.

To mount the battery system in the electric vehicle 2, it is then sufficient to mount and fix the two support parts 16, 18 in the hollow housing 1. Advantageously, the positioning of the two support parts 16, 18, before tightening, is carried out using a template precisely defining the distance between the two support parts 16, 18, but also their position in the hollow housing 1. Moreover, such a template can also be configured to position the two support parts 16, 18 relative to the insertion opening 6, for example by providing, on the template, surfaces for cooperation with the insertion opening 6. In this case, the correct positioning of the template relative to the insertion opening 6 allows correctly positioning the two support parts 16, 18.

Once the two support parts 16, 18 are correctly positioned in the hollow housing 1, the battery 4 can be mounted thereon, in order to allow its depth adjustment thanks to the adjustment of the fixing means 24, 30 of the support parts 16, 18. Such an adjustment then makes it possible to position the cover in the continuity of the wall of the hollow housing 1. Then the cover 8 is positioned relative to the edges of the insertion opening 6.

The positioning can be done to the eye or using a tool 34 illustrated in FIG. 6 and including a body 36 on the periphery of which spacers 38 are disposed. The spacers 38 are positioned to be placed between the cover 8 and the insertion opening 6. Depending on the gap existing between the cover 8 and the insertion opening 6, the spacers 38 are more or less introduced into the intermediate space, until said intermediate space is the same all around the perimeter of the cover 8.

It is then sufficient to tighten the fixing means 15 in order to block the cover 8 in position.

Thus, thanks to the system according to the present disclosure, it becomes easier to integrate a battery discreetly and aesthetically inside an electric vehicle frame. Particularly, it becomes easy to adjust the position of the cover relative to the rest of the frame, in order to obtain desired aesthetic and protective effects.

1. An electric vehicle comprising:
a hollow housing with an opening configured to insert a battery,
a battery including a box extending along a longitudinal direction, between two longitudinal ends and, along a longitudinal side of the box, a cover, and
a battery support mounted inside the hollow housing, so as to allow the installation or withdrawal of the battery on the support, through the insertion opening, the support including two parts configured to cooperate with the two longitudinal ends of the battery box,
wherein, along at least one spatial direction, the two support parts are mounted in a fixed and non-adjustable manner relative to the hollow housing, and wherein the cover is mounted in an adjustable manner on the battery box.

2. The electric vehicle according to claim 1, wherein the two parts of the support and/or the battery box are configured to exert a longitudinal tightening stress between the battery box and the support.

3. The electric vehicle according to claim 1, wherein the battery includes fixing element configured to fix the cover to the box, said fixing element including a tightening system.

4. The electric vehicle according to claim 1, wherein one of the parts of the support comprises a longitudinal tightening member mounted, along the longitudinal direction of the battery box, on an elastic element.

5. The electric vehicle according to claim 1, wherein the cover is substantially planar and wherein the position of the cover can be adjusted relative to the box along at least one spatial direction of the plane of the cover.

6. The electric vehicle according to claim 1, wherein at least one of the two parts of the battery support is made of plastic.

7. A method for mounting a battery support and a battery inside a hollow housing of an electric vehicle with an insertion opening, the battery comprising:
a box extending along a longitudinal direction, between two longitudinal ends, and,
along a longitudinal side of the box, a cover, and the battery support including two parts configured to cooperate with the two longitudinal ends of the battery box,
wherein:
the two parts of the support are fixed inside the hollow housing of an electric vehicle in a non-adjustable manner along at least one spatial direction,
the battery is installed on the support, inside the hollow housing of the electric vehicle, and
the position of the cover is adjusted along said at least one spatial direction on the battery box relative to the insertion opening of the hollow housing.

8. The mounting method according to claim 7, wherein, when the battery is installed on the support, a longitudinal stress is exerted between the two parts of the support and the battery.

9. The mounting method according to claim 7, wherein the two parts of the support are fixed on the hollow housing using a template.

10. The mounting method according to claim 7, wherein the position of the cover is adjusted on the battery box using a set of peripheral spacers simultaneously positioned between the different sides of the cover and the insertion opening when adjusting the position of the cover.

11. The electric vehicle according to claim 1, wherein the cover has dimensions smaller than the dimensions of the insertion opening.

12. The electric vehicle according to claim 1, wherein at least one of the two parts of the support or the battery box are configured to exert a longitudinal tightening stress at the level of the fixing of at least one of the two parts of the support on the inside of the hollow housing.

13. The electric vehicle according to claim 3, wherein the tightening system comprises a screw-nut assembly, mounted in an oblong opening of the box whose dimensions are smaller than those of the nut but greater than those of the screw.

14. The electric vehicle according to claim 1, wherein the position of the cover can be adjusted relative to the box along the two spatial directions of the plane of the cover.

15. The electric vehicle according to claim 1, wherein the position of the cover can be adjusted relative to the box along the longitudinal direction of the box and/or a direction transverse to the longitudinal direction of the box.

16. The mounting method according to claim 7, wherein the position of the cover is adjusted in a centered manner, along said at least one spatial direction on the battery box relative to the insertion opening of the hollow housing.

17. The mounting method according to claim 7, wherein the set of peripheral spacers are a set of V-shaped peripheral spacers.

18. The electric vehicle according to claim 1, wherein said at least one spatial direction is the longitudinal direction of the box or a direction transverse to the longitudinal direction of the box.
